(19) United States
(12) Patent Application Publication
(10) Pub. No.: US 2024/0093807 A1
(43) Pub. Date: Mar. 21, 2024

(54) U-BOLT, CONSTRUCTION METHOD, AND DETECTION DEVICE

(71) Applicant: NIPPON TELEGRAPH AND TELEPHONE CORPORATION, Tokyo (JP)

(72) Inventors: Daiki KOBAYASHI, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/274,497

(22) PCT Filed: Jan. 29, 2021
(86) PCT No.: PCT/JP2021/003352

§ 371 Date: Jul. 27, 2023

(51) Int. Cl. F16L 3/12; G01L 1/24; G01L 1/26

(52) U.S. Cl. CPC F16L 3/1207; G01L 1/247; G01L 1/26

(57) ABSTRACT

A U-bolt (10) according to the present disclosure is a U-bolt (10) including a pair of shaft parts (11) arranged in a first direction and extending in a second direction orthogonal to the first direction, a bridge part (12) connecting one end of each of the pair of shaft parts (11) and includes a photonic crystal thin film (14) which is stuck to at least a part of at least one shaft part (11) of the pair of shaft parts (11) and changes its color according to strain of the shaft part (11).

### TECHNICAL FIELD

The present disclosure relates to a U-bolt, a construction method, and a detection device.

### BACKGROUND ART

Conventionally, U-bolts have been used to fix a fastening object such as a pipe to a fastened object such as a frame or a wall surface. The U-bolt is a U-shaped bolt in which two linear shaft parts are connected by a bridge part. The shaft part of the U-bolt is inserted into each of two through-holes provided in the fastened object in a state of sandwiching the fastening object inside the U-bolt, and fastened from each end part of the two shaft parts by a nut, so that the fastening object can be sandwiched and fixed by the U-bolt and the fastened object.

When the fastening object is fixed to the fastened object by the U-bolt, it is necessary to fix the U-bolt perpendicularly to the fastened object. However, in many cases, the U-bolt is attached structurally in an inclined manner in terms of structure. When the U-bolt is attached in the inclined manner, the U-bolt may be a cause of breakage due to excessive stress.

A technique for providing a piezoelectric patch on a washer inserted into a bolt and measuring a fastening force of the bolt based on a pressure measured by the piezoelectric patch is described in NPL 1. In addition, a technique for embedding a piezoelectric sensor in a shaft part of a bolt and measuring a fastening force of the bolt on the basis of a strain of the shaft part of the bolt measured by the piezoelectric sensor is described in NPL 2.

### CITATION LIST

### Non Patent Literature

[NPL 1] H. Yin, T. Wang, D. Yang, S. Liu, J. Shao, and Y. Li, “A smart washer for bolt looseness monitoring based on piezoelectric active sensing method”, Appl. Sci., vol. 6, No. 11, 2016
[NPL 2] N. Shimoi, C. H. Cuadra, H. Madokoro, and M. Saijo, “Simple Smart Piezoelectric Bolt Sensor for Structural Monitoring of Bridges”, Int. J. Instrum. Sci., vol. 1, No. 5, pp. 78-83, 2013

### SUMMARY OF INVENTION

### Technical Problem

The techniques described in the above-mentioned NPLs 1 and 2 are techniques for measuring the fastening force of a linear bolt, and a worker cannot confirm the fastening state of the shaft part of the U-bolt by a nut by this technique.

An object of the present disclosure, which has been made in view of the above-mentioned problems, is to provide a U-bolt, a construction method, and a detection device that enable a worker to confirm a fastening state of a shaft part of the U-bolt by a nut.

### Solution to Problem

In order to solve the above problem, a U-bolt according to the present disclosure is a U-bolt including a pair of shaft parts arranged in a first direction and extending in a second direction orthogonal to the first direction, and a bridge part connecting one end of each of the pair of shaft parts, and includes a photonic crystal thin film which is stuck to at least a part of at least one shaft part of the pair of shaft parts and changes its color according to strain of the shaft part.

In addition, in order to solve the above problem, a construction method according to the present disclosure is a construction method for fastening a U-bolt, which includes a pair of shaft parts arranged in a first direction, extending in a second direction orthogonal to the first direction, and fastened by a pair of nuts, a bridge part connecting one end of each of the pair of shaft parts, and a photonic crystal thin film which is stuck to at least a part of at least one shaft part of the pair of shaft parts and changes its color according to strain of the shaft part, to a fastened object by using a detection device and includes, by the detection device, a step of generating an observation image obtained by imaging at least a part of at least one shaft part of the pair of shaft parts to which the photonic crystal thin film is stuck, a step of detecting strain of the shaft part based on a color of an observation area including an image of the photonic crystal thin film in the observation image, and a step of outputting fastening information related to fastening of the shaft part by the nut on the basis of the strain.

In addition, in order to solve the above problem, a detection device according to the present disclosure is a detection device that detect a fastening state of the shaft part of a U-bolt, which includes a pair of shaft parts arranged in a first direction, extending in a second direction orthogonal to the first direction, and fastened by a pair of nuts, a bridge part connecting one end of each of the pair of shaft parts, and a photonic crystal thin film which is stuck to at least a part of at least one shaft part of the pair of shaft parts and changes its color according to strain of the shaft part, by the nut and includes an imaging unit that generates an observation image by imaging at least a part of at least one shaft part of the pair of shaft parts to which the photonic crystal thin film is stuck, a detection unit that detects strain of the shaft part to which the photonic crystal thin film is stuck based on a color of an observation region including an image of the photonic crystal thin film in the observation image, and an output unit that outputs fastening information related to the fastening on the basis of the strain.

### Advantageous Effects of Invention

According to a U-bolt, a construction method and a detection device according to the present disclosure, a worker can confirm a fastening state of a shaft part of the U-bolt by a nut.

### BRIEF DESCRIPTION OF DRAWINGS

FIG. 1 is a diagram showing a configuration example of a U-bolt according to a first embodiment.

FIG. 2 is a cross-sectional view of a shaft part shown in FIG. 1 by an XY plane including a central axis of the shaft part.

FIG. 3 is a diagram showing a state in which a fastening object is fixed to a fastened object by the U-bolt shown in FIG. 1.

FIG. 4 is a diagram showing another configuration example of the U-bolt according to the first embodiment.

FIG. 5A is a diagram for explaining tensile force and compressive force acting on the U-bolt when axial force is uniform.

FIG. 5B is a diagram for explaining tensile force and compressive force acting on the U-bolt when axial force is non-uniform.

FIG. 6 is a diagram showing an example of a hardware configuration of a detection device according to the first embodiment.

FIG. 7 is a diagram showing an example of a functional configuration of the detection device according to the first embodiment.

FIG. 8 is a flowchart showing an example of operations of fastening the U-bolt according to the first embodiment.

FIG. 9 is a diagram showing an example of a structure of a U-bolt according to a second embodiment of the present disclosure.

FIG. 10 is a cross-sectional view of the shaft part shown in FIG. 10 by an XY plane including the central axis of the shaft part.

FIG. 11 is a flowchart showing an example of operations of fastening the U-bolt according to the second embodiment.

FIG. 12A is a cross-sectional view of a part of an example of a U-bolt according to a third embodiment by an XY plane including the central axis of the U-bolt.

FIG. 12B is a cross-sectional view of a part of another example of a U-bolt according to the third embodiment by an XY plane including the central axis of the U-bolt.

FIG. 13A is a diagram for explaining a color of PhC thin film shown in FIG. 12A.

FIG. 13B is a diagram for explaining a color of PhC thin film shown in FIG. 12A.

FIG. 13C is a diagram for explaining a color of PhC thin film shown in FIG. 12A.

### DESCRIPTION OF EMBODIMENTS

A description will be given below of embodiments of the present disclosure with reference to the drawings.

### First Embodiment

(Configuration of U-Bolt)

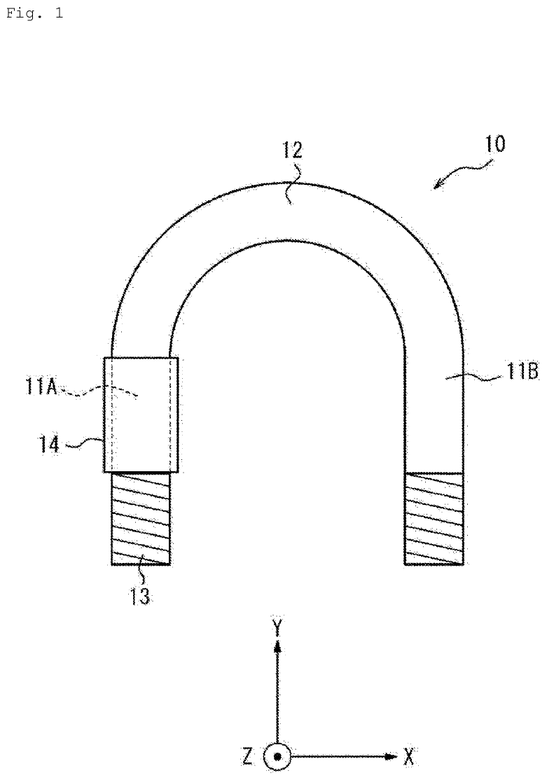

FIG. 1 is a diagram showing a configuration example of a U-bolt 10 according to a first embodiment of the present disclosure.

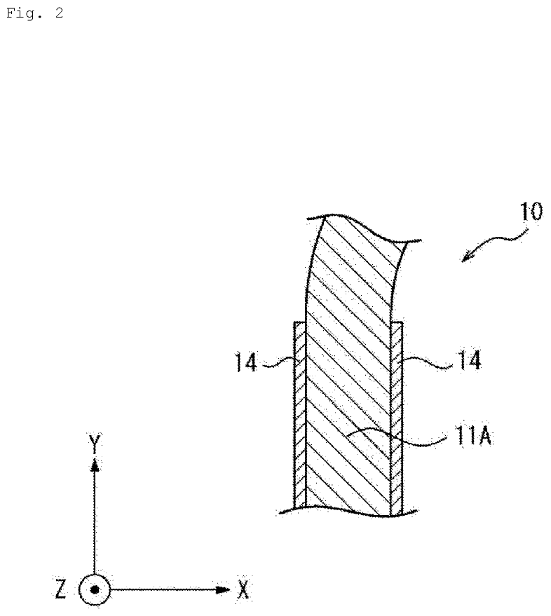

As shown in FIGS. 1 and 2, the U-bolt 10 according to the present embodiment includes a pair of shaft parts 11A and 11B, a bridge part 12, a photonic crystal thin film 14 (referred to “PhC thin film” in below).

The shaft part 11A and the shaft part 11B are arranged in a predetermined direction and extend in a direction orthogonal to the predetermined direction. Hereinafter, as shown in FIG. 1, the direction in which the shaft parts 11A and 11B are arranged side by side is referred to as an X-axis direction (a first direction), the direction in which the shaft parts 11A and 11B extend is referred to as a Y-axis direction (a second direction), and the direction orthogonal to the X-axis direction and the Y-axis direction is referred to as a Z-axis direction (a third direction). When the shaft part 11A and the shaft part 11B are not distinguished from each other, the shaft part 11A and the shaft part 11B are referred to as the shaft part 11. In addition, in the following description, the shaft part 11A and the shaft part 11B are combined and referred to as a pair of shaft parts 11.

The bridge part 12 connects respective one ends of the shaft part 11A and the shaft part 11B. The bridge part 12 can be formed into a semi-circular curved shape, and the bridge part 12 connects one ends of the shaft part 11A and the shaft part 11B, respectively, so that the U-bolt 10 forms a U-shape. The shaft part 11A and the shaft part 11B have a screw part 13 having a screw thread structure on the other end side.

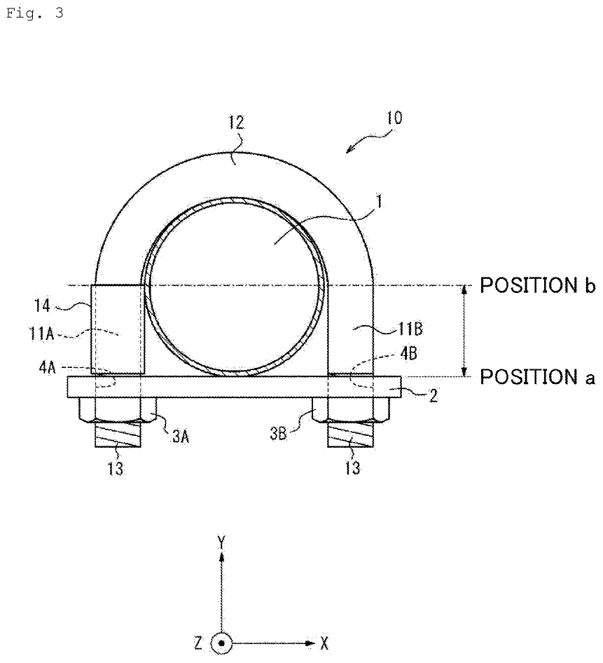

As shown in FIG. 3, a fastening object 1 such as a pipe is arranged in the U-shaped U-bolt 10 (a space surrounded by a pair of shaft parts 11 and a bridge part 12). In a state where the fastening object 1 is arranged inside, a shaft part 11A and a shaft part 11B are inserted from one surface side of the fastened object 2 into a pair of through-holes 4A and 4B provided in the fastened object 2 such as support hardware, respectively. By inserting the shaft part 11A and the shaft part 11B into the through-hole 4A and the through-hole 4B, the screw parts 13 of the shaft part 11A and the shaft part 11B are protruded to the other surface side of the fastened object 2. Nuts 3A and 3B having the screw thread structure screwed with the screw thread structure of the screw part 13 are fastened to the screw parts 13 of the shaft part 11A and the shaft part 11B protruding from the other surface side of the fastened object 2, respectively, and the shaft part 11 is fastened by the nut 3. Thus, the U-bolt 10 is fastened to the fastened object 2, and the fastening object 1 is sandwiched and fixed between the U-bolt 10 and the fastened object 2. Hereinafter, when no distinction is made between the nuts 3A and 3B, they are referred to as the nut 3. In addition, when the through-hole 4A and the through-hole 4B are not distinguished, they are called the through-hole 4.

The PhC thin film 14 is stuck to at least a part of at least one shaft part 11 of the pair of shaft parts 11. In the examples shown in FIGS. 1 and 2, the PhC thin film 14 is stuck to the whole of one shaft part 11A, but is not limited thereto. For example, the PhC thin film 14 may be stuck to a part of one shaft part 11A. Specifically, the PhC thin film 14 may be stuck to a part of an outer edge of a cross section orthogonal to an axis of the shaft part 11, or may be stuck to a part of the outer edge in a direction in which the axis of the shaft part 11 extends.

As shown in FIG. 3, in a state where the shaft part 11A and the shaft part 11B are inserted to a pair of through-holes 4A and 4B provided in the fastened object 2 and the fastening object 1 is sandwiched and fixed between the U-bolt 10 and one surface of the fastened object 2, the PhC thin film 14 may be positioned between a position of one surface of the fastened object 2 (a position a) and a position of a boundary of the shaft part 11 and the bridge part 12 (a position b).

The PhC thin film 14 is a thin film composed of a photonic crystal (PhC). The PhC thin film 14 may be an aggregate of particles such as an opal thin film, or a single-layer thin film or a multilayer thin film composed of a polymer or glass. The PhC thin film 14 may be a thin film utilizing semiconductor process (etching) or a thin film produced by a micro 3D printer.

The PhC thin film 14 changes its colors according to the strain of the PhC thin film 14. Further, the strain corresponding to strain of at least a part of the shaft part 11 to which the PhC thin film 14 is stuck is generated in the PhC thin film 14. Therefore, the PhC thin film 14 changes its colors according to the strain of at least a part of the shaft part 11 to which the PhC thin film 14 is stuck. The PhC thin film 14 is generated by adjusting the particle diameter and the inter-particle distance, and color characteristics indicating the relation between the strain of the PhC thin film 14 and the color characteristic indicating a relationship between the strain of the PhC thin film 14 and the color in which the strain is generated are uniquely determined. The PhC thin film 14 may be generated by adjusting the particle diameter and the inter-particle distance in accordance with the shape and material of each member composing the U-bolt 10 and an axial force to be targeted (force for fastening the shaft part 11 (called “target axial force” below). In addition, the PhC thin film 14 may be generated by adjusting the particle diameter and the inter-particle distance in accordance with a design concept (fastening in an elastic region, fastening in a plastic region). Thus, the worker can recognize the strain of the part of the U-bolt 10 to which the PhC thin film 14 is stuck, based on the color of the PhC thin film 14. Therefore, the worker can fasten the shaft part 11 by the nut 3 so as to generate the strain corresponding to the target axial force acting on the U-bolt 10, and thereby, the U-bolt 10 can be properly fastened.

The PhC thin film 14 may be stuck by application, by adhesion, or by any other method. Note that the scale of the PhC thin film 14 in FIG. 1 is not necessarily the same as the actual scale. This applies likewise to FIGS. 2 to 4.

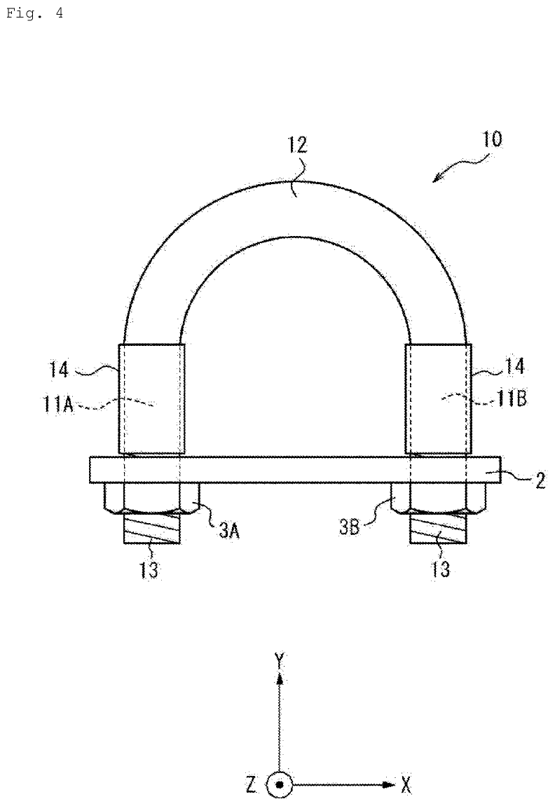

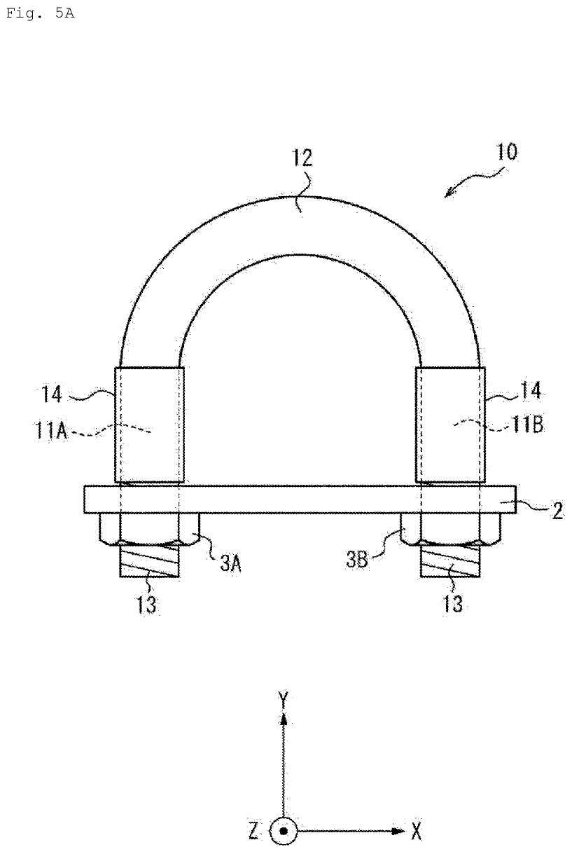

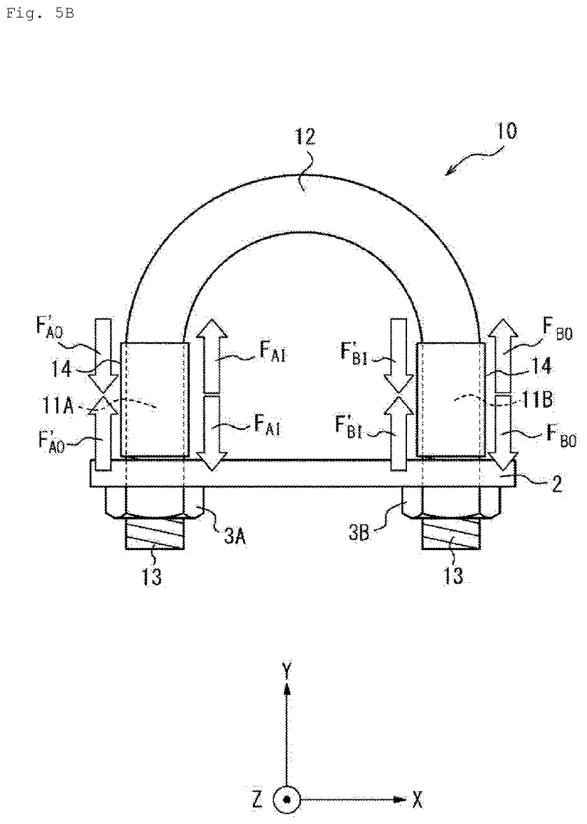

In the examples shown in FIGS. 1 and 3, the configuration in which the PhC thin film 14 is stuck only to the shaft part 11A has been described, but the present disclosure is not limited to this. For example, the PhC thin film 14 may be stuck only to the shaft part 11B. Also, for example, as shown in FIG. 4, a PhC thin film 14 may be stuck to both the shaft part 11A and the shaft part 11B. In the example shown in FIG. 4, the PhC thin film 14 is stuck to the whole of both the shaft part 11A and the shaft part 11B. The PhC thin film 14 may be stuck to each part of both the shaft part 11A and the shaft part 11B and in such a configuration the PhC thin film 14 stuck to the shaft part 11A and the PhC thin film 14 stuck to the shaft part 11B are preferably positioned at the same height (at the same position in the Y-axis direction). Thus, the strain of each of the shaft part 11A and the shaft part 11B, that is, the difference of the axial force acting on each of the shaft part 11A and the shaft part 11B can be accurately measured. FIGS. 5A and 5B are diagrams showing a state in which the U-bolt 10 shown in FIG. 4 is fastened to the fastened object 2. FIG. 5A is a diagram showing tensile force acting on the U-bolt 10 when the axial force acting on the shaft part 11A and the shaft part 11B is uniform. FIG. 5B is a diagram showing tensile force and compressive force acting on the U-bolt 10 when the axial force acting on the shaft part 11A and the shaft part 11B is non-uniform.

As shown in FIG. 5A, when the shaft part 11A and the shaft part 11B are uniformly fastened to the fastened object 2, the tensile forces F_{AO}, F_{AI}, F_{BO}, and F_{BI} of the same magnitude are respectively applied to the outside and inside of the shaft part 11A and the shaft part 11B. Therefore, the axial forces acting on the shaft part 11A and the shaft part 11B are substantially uniform. On the other hand, as shown in FIG. 5B, when the shaft part 11A and the shaft part 11B are non-uniformly fastened to the fastened object 2, the compression forces F′_{AO} and F′_{BI} are generated on the outside of the shaft part 11A and the inside of the shaft part 11B, respectively, and the tensile forces F_{AI} and F_{BO} are generated on the inside of the shaft part 11A and the outside of the shaft part 11B. Therefore, the axial forces acting on the shaft part 11A and the shaft part 11B are not substantially uniform. In order to firmly fix the fastening object 1, it is necessary to make axial forces acting on the shaft part 11A and the shaft part 11B substantially uniform. Therefore, by sticking the PhC thin film 14 to both the shaft part 11A and the shaft part 11B as described above, the worker can confirm whether or not the axial forces acting on the shaft part 11A and the shaft part 11B of the U-bolt 10 to the fastened object 2 are uniform on the basis of the color of the PhC thin film 14 applied to the shaft part 11A and the color of the PhC thin film 14 applied to the shaft part 11B. Thus, the worker can properly fasten the U-bolt 10 to the fastened object 2 by fastening the shaft part 11 by the nut 3 so that the axial forces acting on the shaft part 11A and the shaft part 11B are uniform.

(Hardware Configuration of Detection Device)

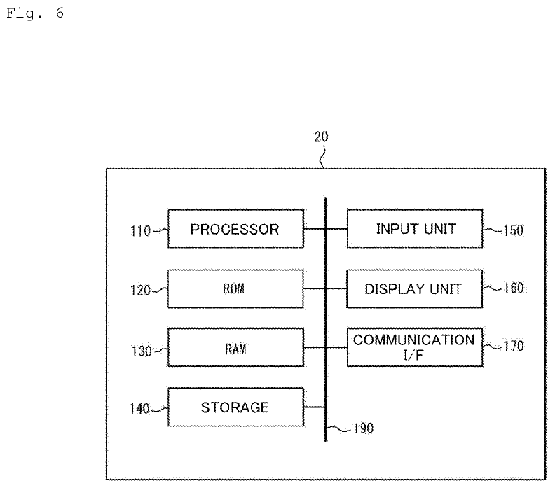

FIG. 6 is a diagram showing an example of a hardware configuration of the detection device 20 according to an embodiment of the present disclosure. FIG. 6 shows an example of the hardware configuration of the detection device 20 when the detection device 20 is constituted by a computer capable of executing a program instruction. Here, the computer may be any of a general-purpose computer, a dedicated computer, a workstation, a PC (Personal Computer), an electronic note pad, a smartphone, or the like. The program instruction may be any of a program code, a code segment, or the like capable of executing a necessary task. When the detection device 20 is the smartphone, the worker can easily carry the detection device 20 to a place where the U-bolt 10 is fastened to the fastened object 2 in installation or inspection of the U-bolt 10, and convenience is improved.

As shown in FIG. 6, the detection device 20 includes a processor 110, a ROM (Read Only Memory) 120, a RAM (Random Access Memory) 130, a storage 140, an input unit 150, a display unit 160, and a communication interface (I/F) 170. The respective configurations are connected to each other via a bus 190 so as to be relatively communicable. Specifically, the processor 110 may be any of a CPU (Central Processing Unit), an MPU (Micro Processing Unit), a GPU (Graphics Processing Unit), a DSP (Digital Signal Processor), a SoC (System on a Chip), or the like, and may be constituted by a plurality of processors of the same kind or different kinds.

The processor 110 executes control of each configuration and various arithmetic processing. More specifically, the processor 110 reads the program from the ROM 120 or the storage 140 and executes the program using the RAM 130 as a working area. The processor 110 controls the respective configurations described above and performs various types of arithmetic processing in accordance with the program stored in the ROM 120 or the storage 140. In this embodiment, a program according to the present disclosure is stored in the ROM 120 or the storage 140.

The program may be provided by being stored on a non-transitory storage medium such as a CD-ROM (Compact Disk Read Only Memory), a DVD-ROM (Digital Versatile Disk Read Only Memory), or a USB (Universal Serial Bus) memory. In addition, the program may be downloaded from an external device over a network.

The ROM 120 stores various programs and various types of data. The RAM 130 temporarily stores programs or data as a working area. The storage 140 is configured of a hard disk drive (HDD) or a solid state drive (SSD), and stores various programs including an operating system and various types of data.

The input unit 150 includes a pointing device such as a mouse and a keyboard, and is used to input various types of input. The display unit 160 is a liquid crystal display, for example, and displays various information. By employing a touch panel system, the display unit 160 may also function as the input unit 150.

The communication I/F 170 is an interface for communicating with other equipment such as an external device (not shown) and a standard such as Ethernet (registered trademark), FDDI, or Wi-Fi (registered trademark) is used, for example.

(Functional Configuration of Detection Device)

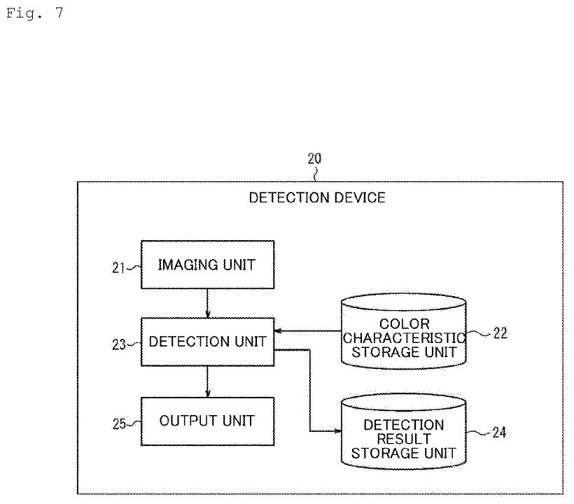

Next, a functional configuration of the detection device 20 according to the present disclosure will be described with reference to FIG. 7.

FIG. 7 is a diagram showing an example of the functional configuration of the detection device 20 according to the present disclosure. The detection device 20 according to the present disclosure detects a state of fastening of the shaft part 11 of the U-bolt 10 by the nut 3, and outputs fastening information related to fastening.

As shown in FIG. 7, the detection device 20 according to the present disclosure includes an imaging unit 21, a color characteristic storage unit 22, a detection unit 23, a detection result storage unit 24, and an output unit 25. The imaging unit 21 is constituted of a camera. The color characteristic storage unit 22 and the detection result storage unit 24 are constituted of, for example, a RAM 130 or a storage 140. The detection unit 23 constitutes a control unit (controller). The control unit may be constituted by dedicated hardware such as an ASIC (Application Specific Integrated Circuit) and an FPGA (Field-Programmable Gate Array), or may be constituted by a processor, or may be constituted by including both. The output unit 25 may include, for example, the display unit 160.

The imaging unit 21 generates an observation image by imaging at least a part of at least one shaft part 11 of the pair of shaft parts 11 to which the PhC thin film 14 is stuck. Thereafter, an area in which at least a part of an image of at least one shaft part 11 of the pair of shaft parts 11 to which the PhC thin film 14 is stuck in the observation image is indicated is referred to as an observation area.

The color characteristic storage unit 22 stores color characteristics indicating a relation between a strain ε of the PhC thin film 14 and a color of the PhC thin film 14 in which the strain ε occurs. The color stored in the color characteristic storage unit 22 is indicated by, for example, RGB values.

The detection unit 23 detects the strain ε of at least a part of the shaft part 11 to which the PhC thin film 14 is stuck on the basis of an observation region in the observation image generated by the imaging unit 21. Specifically, the detection unit 23 detects a representative value of pixels constituting an observation area in the observation image. The representative value is, for example, a value related to RGB values of pixels constituting the observation area, and for example, can be an average value, a median value, a maximum value, or a minimum value of an R value, a G value and a B value, respectively. Then, the detection unit 23 detects the strain ε stored in the color characteristic storage unit 22 corresponding to the representative value indicated by the RGB values.

In addition, the detection unit 23 can detect a target difference Δε₁ which is a difference between the strain ε and the target strain ε_{T}. In this case, the detection unit 23 can further detect whether or not the absolute value of the target difference Δε₁ is less than a predetermined threshold value. The target strain ε_{T} is a strain ε generated in the shaft part 11 on which the above-mentioned target axial forces act.

When PhC thin films 14 are stuck to both shaft parts 11A and 11B and observation images of both shaft parts 11A and 11B are generated by the imaging unit 21, the detection unit 23 detects a first representative value and a second representative value based on colors of pixels constituting observation areas of both shaft parts 11A and 11B. Then, the detection unit 23 can detect strain ε_{A} and strain ε_{B} of both the shaft parts 11A and 11B, respectively, on the basis of the first representative value and the second representative value.

In this case, the detection unit 23 can detect target differences Δε_{1A} and Δε_{1B} is which are differences between the strain ε_{A} and the strain ε_{B} and the target strain ε_{T} as the target difference Δε₁. In this case, the detection unit 23 can further detect whether or not the absolute values of the target differences Δε_{1A} and Δ ε is are less than the predetermined threshold value.

Further, the detection unit 23 can detect a relative difference Δε₂ which is a difference between the strain ε_{A} and the strain ε_{B}. In this case, the detection unit 23 can further detect whether or not the absolute value of the relative difference Δε₂ is less than the predetermined threshold value.

The fastening information includes at least one of the strain ε, the target difference Δε₁, the target difference index, the relative difference Δε₂, and the relative difference index. The target difference index is information indicating whether or not the absolute value of the target difference Δε₁ is less than the predetermined threshold value. The relative difference index is information indicating whether or not the absolute value of the relative difference Δε₂ is less than the predetermined threshold value.

When the detection unit 23 judges that the absolute value of the target difference Δε₁ is less than the predetermined threshold value, the fastening information may include information indicating that fastening of the U-bolt 10 is completed in place of the target difference index. In addition, when the detection unit 23 judges that the absolute value of the target difference Δε₁ is equal to or greater than the predetermined threshold value, the fastening information may include information indicating that fastening of the U-bolt 10 is not completed in place of the target difference index.

Further, when the detection unit 23 judges that the absolute value of the relative difference Δε₂ is less than the predetermined threshold value, the fastening information may include information indicating that the shaft part 11A and the shaft part 11B are fastened substantially uniformly in place of the relative difference index. Furthermore, when the detection unit 23 judges that the absolute value of the relative difference Δε₂ is equal to or more than the predetermined threshold value, the fastening information may include information indicating that the shaft part 11A and the shaft part 11B are not fastened substantially uniformly in place of the relative difference index.

The detection result storage unit 24 stores the fastening information detected by the detection unit 23. Thus, for example, evidence that the fastening of the normal construction (the fastening of U-bolt 10) is completed can be left.

The output unit 25 outputs fastening information related to fastening of the shaft part 11 of the U-bolt 10 by the nut 3 based on the strain ε detected by the detection unit 23.

(Construction Method for Attaching U-bolt)

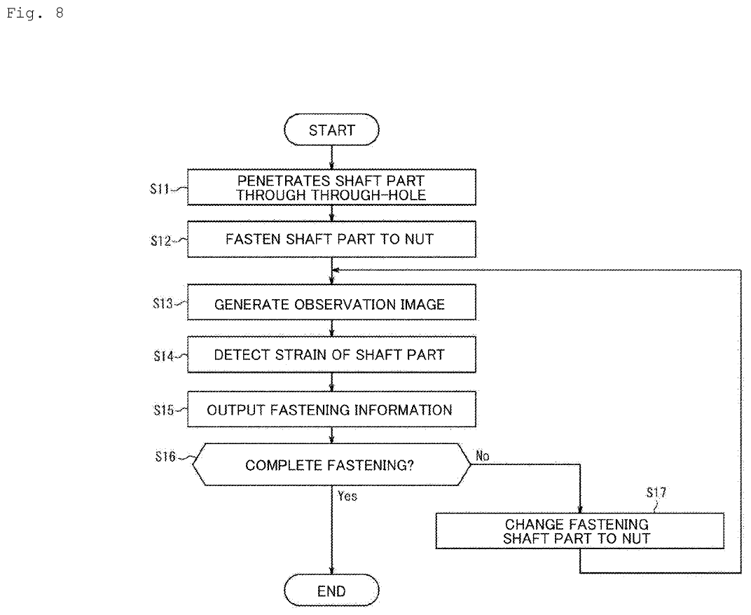

Here, an operation for fastening the U-bolt 10 according to the first embodiment will be described with reference to FIG. 8. FIG. 8 is a flowchart showing an example of the operation for fastening the U-bolt 10 according to the first embodiment. The operation for fastening the U-bolt 10 described with reference to FIG. 8 corresponds to the construction method for fastening the U-bolt 10 according to the first embodiment.

In a step S11, the worker penetrates the shaft part 11A and the shaft part 11B of the U-bolt 10 through the through-hole 4A and the through-hole 4B, respectively.

In a step S12, the worker fastens the shaft part 11A and the shaft part 11B by a nut 3A and a nut 3B, respectively.

In a step S13, the imaging unit 21 of the detection device 20 generates the observation image in which at least a part of at least one shaft part 11 of the pair of shaft parts 11 to which the PhC thin film 14 is stuck is imaged.

In a step S14, the detection unit 23 detects the strain ε of at least one of the shaft part 11A and the shaft part 11B to which the PhC thin film 14 is stuck on the basis of the observation area in the observation image generated by the imaging unit 21. Specifically, the detection unit 23 detects the representative value based on the color of the pixel constituting the observation area in the observation image. Then, the detection unit 23 detects the strain ε stored in the color characteristic storage unit 22 corresponding to the representative value. The detection unit 23 may detect the target difference Δε₁ on the basis of the strain ε. The detection unit 23 may judge whether or not the absolute value of the target difference Δε₁ is less than the predetermined threshold value.

In addition, in a step S14, the detection unit 23 may detect the strain ε of one of the shaft part 11A and the shaft part 11B. The detection unit 23 may detect the strain ε of both the shaft part 11A and the shaft part 11B. The detection unit 23 may detect the relative difference Δε₂ when detecting the strain ε of both the shaft part 11A and the shaft part 11B. The detection unit 23 may judge whether or not an absolute value of the relative difference Δε₂ is less than the predetermined threshold value.

In a step S15, the output unit 25 outputs fastening information detected by the detection unit 23.

In a step S16, the worker judges whether or not the fastening processing is completed on the basis of the fastening information.

At this time, when the strain ε included in the fastening information outputted in the step S15 is within a predetermined range from the target strain ε_{T}, the worker may judge that the fastening processing has been completed. In this case, when the strain ε is not within the predetermined range from the target strain ε_{T}, the worker judges that the fastening processing has not been completed.

When the absolute value of the target difference Δε₁ included in the fastening information outputted in the step S15 is less than the predetermined threshold value, the worker may judge that the fastening processing has been completed. In this case, when the absolute value of the target difference Δε₁ is equal to or greater than the predetermined threshold value, the worker may determine that the fastening process has not been completed.

When the target difference index included in the fastening information outputted in the step S15 indicates that the absolute value of the target difference Δε₁ is less than the predetermined threshold value, it may be judged that the worker completes the fastening processing. In this case, when the target difference index indicates that the absolute value of the target difference Δε₁ is equal to or greater than the predetermined threshold value, it may be determined that the worker does not complete the fastening process.

In the step S16, when it is determined that the fastening processing is completed, the fastening processing is completed. When it is determined in the step S16 that the fastening processing has not been completed, in a step S17, the worker changes fastening of the shaft part 11 on the basis of the fastening information.

When the fastening of the shaft part 11 is changed in the step S17, the processing is returned to the step S13 and the processing is repeated. In the repetition of the processing of the step S13 to the step S17, the worker may change the fastening of one of the shaft part 11A and the shaft part 11B or may change the fastening of both of the shaft part 11A and the shaft part 11B based on the fastening information. Further, the worker changes fastening of the shaft part 11A or the shaft part 11B so as to reduce the relative difference Δε 2 on the basis of the relative difference Δε₂ included in the fastening information, may further change fastening of the shaft part 11A and the shaft part 11B so that the target difference Δε₁ becomes small while maintaining a state where the relative difference Δε₂ is less than the predetermined threshold value.

As described above, according to the first embodiment, the U-bolt 10 includes the PhC thin film 14 which is stuck to at least a part of at least one shaft part 11 of the pair of shaft parts 11 and changes its color according to the strain of the shaft part 11. Thus, the shaft part 11 can be fastened by the nut 3 so that the strain ε of the shaft part 11 becomes the target strain ε_{T}, that is, the target axial forces act on the shaft part 11. Therefore, the worker can fasten the U-bolt 10 to the fastened object 2 with high accuracy, and the fastened object 1 can be firmly fixed accordingly.

In addition, according to the first embodiment, in a state where a pair of shaft parts 11A and 11B are inserted into a pair of through holes 4A and 4B provided in the fastened object 2 and the fastening object 1 is sandwiched and fixed between the U-bolt 10 and one surface of the fastened object 2, the PhC thin film 14 is positioned between one surface of the fastened object 2 and a boundary between the shaft part 11 and the bridge part 12 in at least one shaft part 11. Thus, when the U-bolt 10 is attached to the fastened object 2, the worker can recognize the strain corresponding to axial forces acting on the shaft part 11 required for firmly fixing the fastening object 1, and can firmly fix the fastening object 1.

Further, in a configuration in which the PhC thin film 14 is stuck to both of the shaft part 11A and the shaft part 11B, the PhC thin film 14 is positioned between one surface of the fastened object 2 and a boundary between the shaft part 11 and the bridge part 12 in each of both of the shaft part 11A and the shaft part 11B. Thus, the worker can perform work so that the difference in color of the PhC thin film 14 stuck to the shaft part 11A and the shaft part 11B does not become large when the U-bolt 10 is attached to the fastened object 2. Therefore, the worker can fasten the shaft part 11 by the nut 3, and thereby, the U-bolt 10 can be properly fastened to the fastened object 2.

In addition, according to the first embodiment, the detection device 20 outputs fastening information based on the target difference Δε₁. Therefore, the worker can fasten the shaft part 11 by the nut 3 so that the strain ε generated in the U-bolt 10 becomes the target strain ε_{T}, that is, the target axial force acts on the U-bolt 10. Therefore, the worker can fasten the U-bolt 10 to the fastened object 2 with high accuracy, and the fastening object 1 can be firmly fixed accordingly.

In addition, according to the first embodiment, the detection device 20 outputs fastening information based on the relative difference Δε₂. In fastening the U-bolt 10 to the fastened object 2, it is necessary to maintain a state in which the strain ε_{A} of the shaft part 11A and the strain ε_{B} of the shaft part 11B are approximately the same not only when fastening is completed but also in the middle of work until fastening is completed. The worker not only sets the strain ε A and the strain ε_{B} as the target strain ε_{T}, but also needs to reduce the relative difference Δε₂ which is the difference between the strain ε_{A} and the strain ε_{B} during the work. Therefore, as described above, when the detection device 20 outputs fastening information based on the relative difference Δε₂, the worker can recognize the relative difference Δε₂ during the work, and perform fastening the shaft part 11 by the nut 3 on the basis of the relative difference. Therefore, the worker can fasten the U-bolt 10 to the fastened object 2 with high accuracy, and the fastening object 1 can be firmly fixed accordingly.

### Second Embodiment

(Configuration of U-bolt)

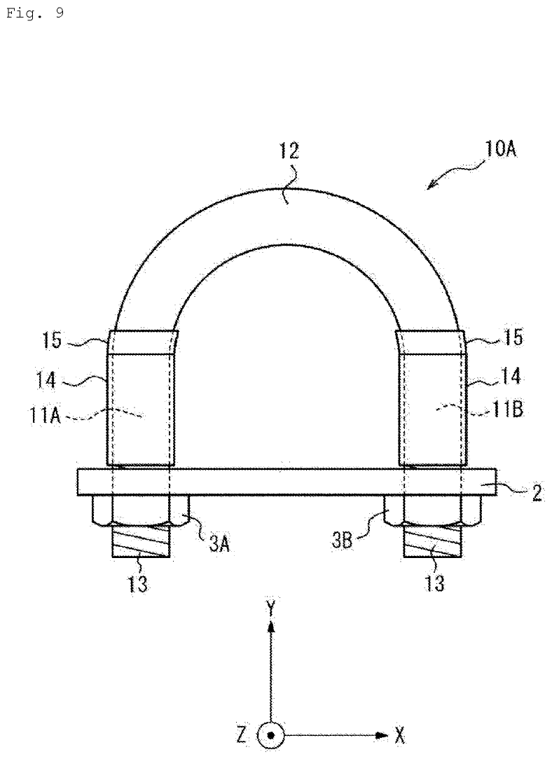

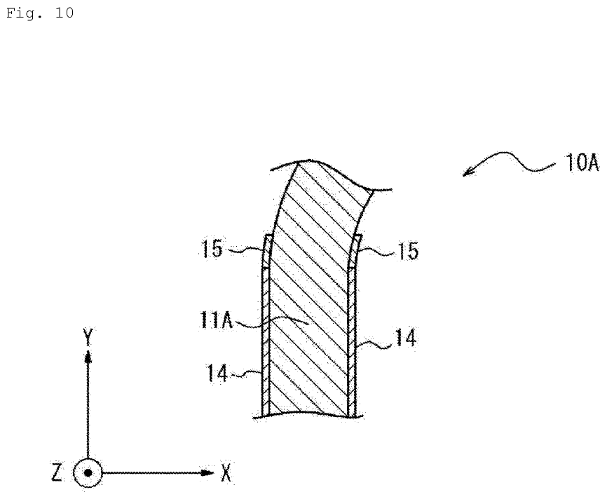

FIG. 9 is a diagram showing an example of the structure of a U-bolt 10A according to a second embodiment of the present disclosure. FIG. 10 is a cross-sectional view by an XY plane including a central axis of the U-bolt 10A shown in FIG. 9. In FIGS. 9 and 10, the same reference signs are given to structures that are similar to those in FIG. 4, and a description thereof will be omitted.

The U-bolt 10A according to the present embodiment further includes a reference thin film 15 as compared with the U-bolt 10 according to the first embodiment. Note that the scale of the PhC thin film 14 and the reference thin film 15 in FIGS. 9 and 10 is not necessarily the same as the actual scale.

The reference thin film 15 is a coating film which is stuck to at least a part of a portion different from a portion to which the PhC thin film 14 is stuck in the U-bolt 10 a, does not change its color according to the strain, and has a color of the PhC thin film 14 when target axial forces act on the shaft part 11.

In the example shown in FIGS. 9 and 10, the reference thin film 15 is stuck to the bridge part 12 adjacent to the part to which the PhC thin film 14 is attached. Thus, the worker fastening the U-bolt 10A can easily visually recognize the colors of the PhC thin film 14 and the reference thin film 15 without moving the line of sight. The reference thin film 15 may be stuck by application, stuck by adhesion, or stuck by any other method, as in the case of the PhC thin film 14.

In the examples shown in FIGS. 9 and 10, the reference thin film 15 is stuck adjacent to the PhC thin film 14, but the reference thin film 15 is not limited thereto, and may be stuck not adjacent to the PhC thin film 14. In the examples shown in FIGS. 9 and 10, the reference thin film 15 is stuck over the entire outer edge of the cross section orthogonal to the axis of the U-bolt 10A, but may be stuck to a part of the outer edge. In addition, in the examples shown in FIGS. 9 and 10, the PhC thin film 14 is stuck to the entire shaft part 11 and the reference thin film 15 is stuck to a part of the bridge part 12, but this is not limited thereto. The PhC thin film 14 may be stuck to a part of the shaft part 11, and the reference thin film 15 may be stuck to the shaft part 11 of a part to which the PhC thin film 14 is not stuck.

(Construction Method for Attaching U-bolt)

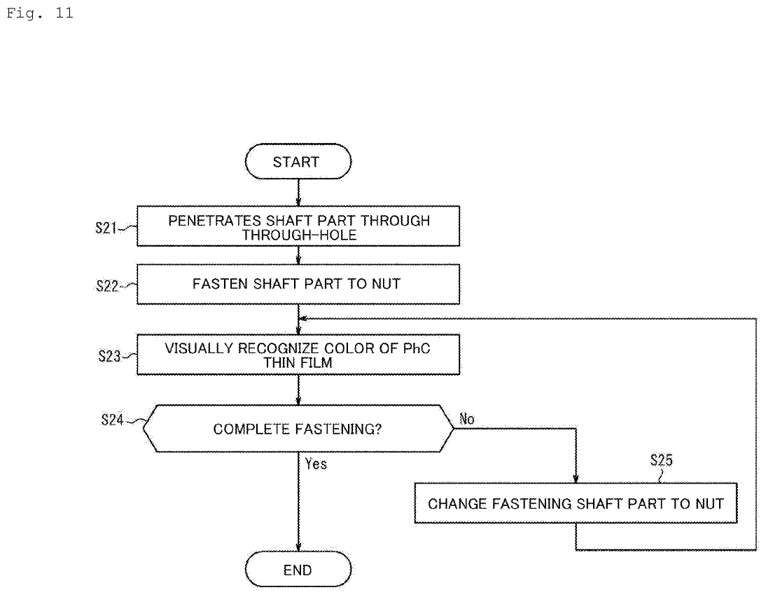

An operation for fastening the U-bolt 10A according to the second embodiment will now be described with reference to FIG. 11. FIG. 11 is a flowchart showing an example of an operation for fastening the U-bolt 10A according to the second embodiment. The operation for fastening the U-bolt 10A described with reference to FIG. 11 corresponds to the construction method for fastening the U-bolt 10A according to the second embodiment.

In a step S21, the worker penetrates the shaft part 11A and the shaft part 11B of the U-bolt 10A through the through-hole 4A and the through-hole 4B, respectively.

In a step S22, the worker fastens the shaft part 11A and the shaft part 11B by the nut 3A and the nut 3B, respectively.

In a step S23, the worker visually recognizes the color of the PhC thin film 14.

In a step S24, the worker judges whether the fastening processing is completed or not on the basis of the color of the PhC thin film 14. Specifically, the worker judges whether or not the color of the PhC thin film 14 and the color of the reference thin film 15 are substantially the same. Then, when the worker judges that the color of the PhC thin film 14 and the color of the reference thin film 15 are substantially the same, it is judged that the fastening processing is completed. When the worker judges that the color of the PhC thin film 14 and the color of the reference thin film 15 are not substantially the same, the fastening processing is not completed.

When it is judges that the fastening processing is completed in a step S24, the fastening processing is completed. When it is judges in the step S24 that the fastening processing is not completed, in a step S25, the worker changes the fastening of the shaft part 11 on the basis of the fastening information. At this time, the worker may change the fastening of one of the shaft part 11A and the shaft part 11B or may change the fastening of both the shaft part 11A and the shaft part 11B based on the degree of similarity between the color of the PhC thin film 14 and the color of the reference thin film 15.

When the fastening of the shaft part 11 is changed in the step S25, the processing is returned to the step S23 and the processing is repeated. In repeating the processing of the step S23 to the step S25, the worker changes the fastening of the shaft part 11A or the shaft part 11B so that the degree of similarity of the colors of the PhC thin films 14 stuck to the shaft part 11A and the shaft part 11B becomes high, and further changes the fastening of the shaft part 11A and the shaft part 11B so that the degree of similarity between the color of the PhC thin film 14 and the color of the reference thin film 15 becomes high.

As described above, according to the present embodiment, the U-bolt 10A further includes the reference thin film 15 which is stuck to at least a part of a portion different from the portion to which the PhC thin film 14 is stuck and which does not change its color according to the strain. In a configuration in which the U-bolt 10A does not include the reference thin film 15, the worker performs work by comparing the color of the PhC thin film 14 with the color corresponding to the target strain ε_{T} stored by itself. Therefore, it is sometimes difficult to fasten the U-bolt 10A to the fastened object 2 so that the strain ε is the target strain ε_{T} in the shaft part 11. On the other hand, according to the present embodiment, when fastening the U-bolt 10A so that the color of the PhC thin film 14 becomes substantially the same as the color corresponding to the target strain ε_{T}, the worker compares the color of the PhC thin film 14 with the color of the reference thin film 15 which is the color corresponding to the target strain ε_{T} to fasten the shaft part 11 by the nut 3 so that the target strain ε_{T} is generated in the shaft part 11. Therefore, the worker can fasten the U-bolt 10A to the fastened object 2 with high accuracy, and the fastening object 1 can be firmly fixed accordingly.

Further, according to the present embodiment, since the worker can appropriately recognize the strain of the U-bolt 10A by visual observation, it can be easily confirmed whether the U-bolt 10A is properly fastened in the construction and the inspection. In particular, in an environment such as a high place where it is difficult to confirm the strain ε of the U-bolt 10A by palpation, the worker can greatly save labor for approaching the environment.

### Third Embodiment

(Configuration of U-bolt)

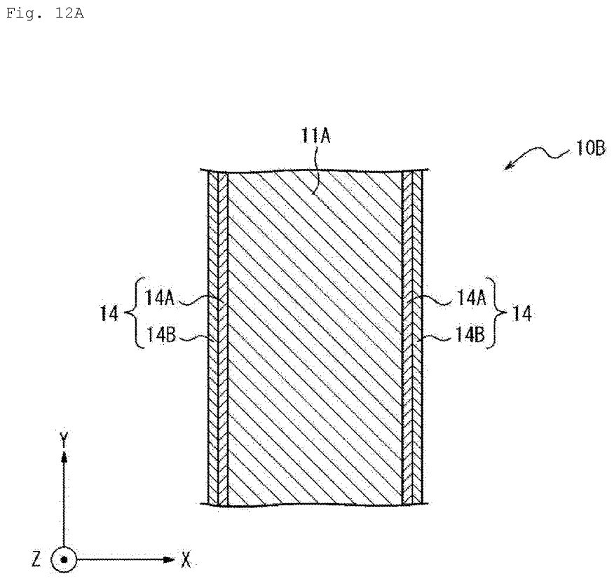

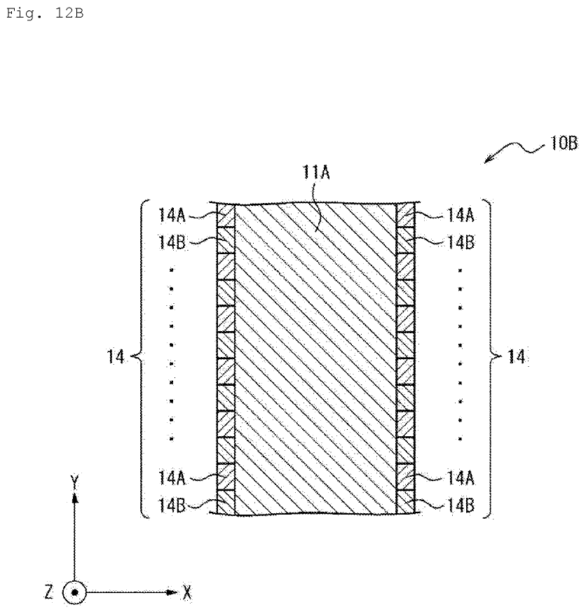

FIGS. 12A and 12B are cross sectional views showing an example of a part of a U-bolt 10B according to a third embodiment of the present disclosure. Further, in FIGS. 12A and 12B, the same reference signs are given to structures that are similar to those in FIG. 4, and a description thereof will be omitted. In the present embodiment, the PhC thin film 14 provided in the U-bolt 10B is different from the PhC thin film 14 provided in the U-bolt 10 according to the first embodiment, and is composed of a plurality of PhC thin films 14A and 14B as shown in FIGS. 12A and 12B. In one example, the PhC thin film 14A and the PhC thin film 14B are laminated on the surface of the shaft part 11 of the U-bolt 10B in the radial direction of the shaft part 11 as shown in FIG. 12A. In another example, the PhC thin film 14A and the PhC thin film 14B are alternately arranged in the axial direction of the shaft part 11 on the surface of the shaft part 11 of the U-bolt 10B as shown in FIG. 12B. Note that the scales of the PhC thin film 14A and the PhC thin film 14B in FIGS. 12A and 12B are not necessarily the same as the actual scales. In particular, the PhC thin film 14A and the PhC thin film 14B in FIG. 12B have such sizes that the colors of the PhC thin film 14A and the PhC thin film 14B are mixed and visually recognized by human eyes.

The PhC thin film 14 is constituted of a plurality of PhC thin films 14A and 14B having mutually different color characteristics. A difference between a first color in which the respective colors of the plurality of PhC thin films 14A and 14B are mixed when the strain ε is within a first range and a second color in which the respective colors of the plurality of PhC thin films 14A and 14B are mixed when the strain ε is within a second range is larger than the difference between the third color of the PhC thin film 14A in the case when the strain ε is within the first range and the fourth color of the PhC thin film 14A in the case when the strain ε is within the second range. The difference (color difference) between the color in the case when the strain ε is within the second range and the color in the case when the strain ε is within the third range can be made similar. For example, when the strain ε is within the first range, the plurality of PhC thin films 14A and 14B may develop color by reflecting mutually different visible light. When the strain s is within the second range different from the first range, the PhC thin film 14A may develop color by reflecting visible light, and the PhC thin film 14B may not develop color by reflecting light having a wavelength outside the visible light region.

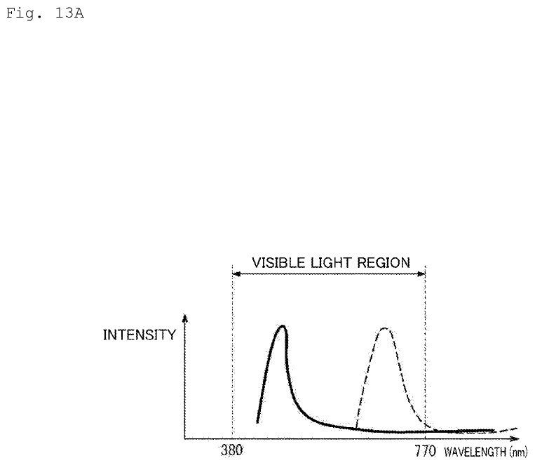

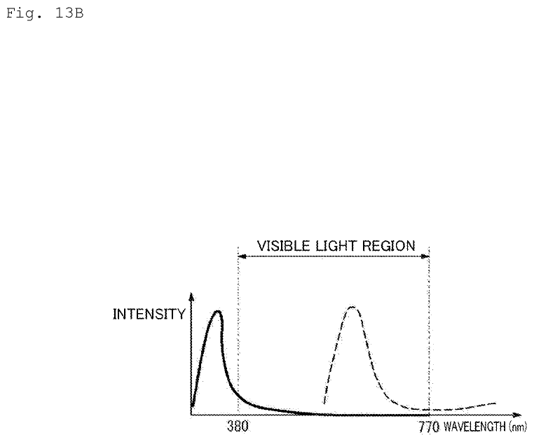

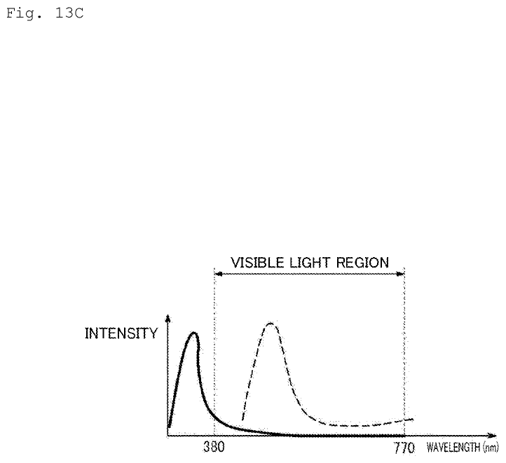

Referring to FIG. 13A to FIG. 13C, the color of the PhC thin film 14 including the PhC thin film 14A and the PhC thin film 14B will be described in more detail.

As shown by a broken line in FIG. 13A, the PhC thin film 14A reflects light having a wavelength of 640 to 770 nm when the axial force is not generated (the strain ε is within the first range). That is, the PhC thin film 14A becomes red when no axial forces are generated. Also, as shown by the broken line in FIG. 13B, the PhC thin film 14A reflects light having the wavelength of 590 to 640 nm when the axial force is larger than 0 and less than the intermediate axial force (when the strain ε is within the second range). That is, the PhC thin film 14A becomes orange when the axial force is larger than 0 and less than the intermediate axial force. Note that the intermediate axial force is an axial force smaller than a target axial force generated in a state where the fastening of the U-bolt 10B is completed, and for example, may be the axial force of the magnitude of 50% of the target axial force. Further, as shown by the broken line in FIG. 13C, when the axial force is equal to or more than the intermediate axial force and less than the target axial force (when the strain ε is within the third range), the PhC thin film 14A reflects light having the wavelength of 490 to 550 nm. That is, the PhC thin film 14A becomes green when the axial force is equal to or more than the intermediate axial force and less than the target axial force.

Further, as shown by a solid line in FIG. 13A, the PhC thin film 14B reflects light having a wavelength of 490 to 550 nm when the axial force is not generated. That is, the PhC thin film 14B becomes green when no axial force is generated. Further, as shown by the solid line in FIG. 13B, the PhC thin film 14B reflects light having the wavelength of 315 to 400 nm when the axial force is larger than 0 and less than the intermediate axial force. That is, the PhC thin film 14B does not generate the color recognizable by a human when the axial force is larger than 0 and less than the intermediate axial force. Further, as shown by the solid line in FIG. 13C, the PhC thin film 14B reflects light having the wavelength of 280 to 315 nm when the axial force is equal to or more than the intermediate axial force and less than the target axial force. That is, the PhC thin film 14B does not generate the color recognizable by the human when the axial force is equal to or more than the intermediate axial force and less than the target axial force.

Therefore, the PhC thin film 14 composed of the PhC thin film 14A and the PhC thin film 14B is visually recognized as a purple color which is a color mixture of red and green colors for human eyes when the axial force is not generated (when the strain ε is within the first range). And, when the axial force is larger than 0 and less than the intermediate axial force (when the strain ε is within the second range), the PhC thin film 14 is visually recognized as an orange color for human eyes. The PhC thin film 14 is visually recognized in green for human eyes when the axial force is equal to or more than the intermediate axial force and less than the target axial force.

For example, when the PhC thin film 14 is composed of only one kind of PhC thin film 14A, the wavelength of light reflected by the PhC thin film 14 becomes shorter as the axial force becomes higher. That is, the color of the PhC thin film 14 changes in the order of red, orange and green. In this case, the red color and the orange color are sometimes difficult to be distinguished by human eyes. On the other hand, when the PhC thin film 14 is composed of two PhC thin films 14A and 14B as in this embodiment, the color of the PhC thin film 14 is, as described above, changed in the order of purple, orange, and green. Since purple and orange are easily distinguished from red and orange for human eyes, the worker can easily recognize the change in axial force.

Although the PhC thin film 14 is composed of two PhC thin films 14A and 14B in the above example, the present invention is not limited thereto, and may be composed of three or more PhC thin films 14 having different color characteristics.

(Hardware Configuration of Detection Device)

A hardware configuration of the detection device 20 according to the third embodiment is similar to the hardware configuration of the detection device 20 according to the first embodiment.

(Functional Configuration of Detection Device)

A functional configuration of the detection device 20 according to the third embodiment is similar to the functional configuration of the detection device 20 according to the first embodiment.

(Construction Method for Attaching U-bolt)

The construction method for attaching the U-bolt 10B according to the third embodiment is the same as the construction method for attaching the U-bolt 10 according to the first embodiment.

As described above, according to the third embodiment, the PhC thin film 14 is composed of a plurality of PhC thin films 14 having different color characteristics from each other. Then, the difference between the first color in which the respective colors of the plurality of PhC thin films 14 are mixed when the strain ε is within the first range and the second color in which the respective colors of the plurality of PhC thin films 14 are mixed when the strain ε is within the second range is larger than the difference the third color of one PhC thin film 14 from among the plurality of PhC thin films 14 when the strain ε is within the first range and the fourth color of one PhC thin film 14 when the strain ε is within the second range. Thus, the worker can clearly identify the color of the PhC thin film 14 corresponding to the strain ε, and can properly fasten the shaft part 11 to the nut 3. Therefore, the worker can fasten the U-bolt 10B to the fastened object 2 with high accuracy, and the fastening object 1 can be firmly fixed accordingly.

In addition, according to the third embodiment, since the U-bolt 10B includes the PhC thin films 14 as described above, the detection device 20 can measure the strain ε of the shaft part 11 with higher accuracy. Thus, the worker can fasten the shaft part 11 by the nut 3 by using fastening information outputted on the basis of the strain ε measured with high accuracy by the detection device 20. Therefore, the worker can fasten the U-bolt 10B to the fastened object 2 with high accuracy, and the fastening object 1 can be firmly fixed accordingly.

<Program>

A computer can be suitably used to function as the units of the detection device 20 described above. Such a computer can be realized by storing a program describing the details of processing realizing the functions of the detection device 20 in a storage unit of the computer and allowing a processor of the computer to read and execute the program. That is, the program can cause the computer to function as the above-described detection device 20. Further, the program can be stored in a non-temporary storage medium. The program may also be provided via a network.

While one embodiment has been described above as a typical example, it is clear for a person skilled in the art that many alterations and substitutions are possible without departing from the subject matter and scope of the present disclosure. Therefore, the embodiment described above should not be interpreted as limiting and the present invention can be modified and altered in various ways without departing from the scope of the claims. For example, a plurality of configuration blocks shown in the configuration diagram of the embodiment may be combined to one, or one configuration block may be divided.

### REFERENCE SIGNS LIST

1 Fastening object
2 Fastened object
3, 3A, 3B Nut
4, 4A, 4B Through-hole
10, 10A, 10B U-bolt
11, 11A, 11B Shaft part
12 Bridge part
13 Screw part
14, 14A, 14B Photonic crystal thin film (PhC thin film)
20 Detection device
21 Imaging unit
22 Color characteristic storage unit
23 Detection unit
24 Detection result storage unit
25 Output unit
110 Processor
120 ROM
130 RAM
140 Storage
150 Input unit
160 Display unit
170 Communication I/F
190 Bus

1. A U-bolt comprising:
a pair of shaft parts arranged in a first direction and extending in a second direction orthogonal to the first direction,
a bridge part connecting one end of each of the pair of shaft parts, and
a photonic crystal thin film, wherein the photonic crystal thin film is stuck to at least a part of at least one shaft part of the pair of shaft parts, and
the photonic crystal thin film changes its color according to strain of the shaft part.

2. The U-bolt according to claim 1, wherein
in a state where the pair of shaft parts are inserted into a pair of through-holes provided in a fastened object and a fastening object is sandwiched and fixed between the U-bolt and one surface of the fastened object, the photonic crystal thin film is positioned between one surface of the fastened object and a boundary between the shaft part and the bridge part in at least one shaft part.

3. The U-bolt according to claim 1 further comprising:
a reference thin film, wherein the reference thin film is stuck to at least a part of a portion different from a portion to which the photonic crystal thin film is stuck, the reference thin film does not change its color according to the strain, and the reference thin film has the color of the photonic crystal thin film when a target axial force acts on the shaft part.

4. The U-bolt according to claim 1 wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.

5. A construction method, comprising:
fastening a U-bolt to an object by a nut, wherein a pair of shaft parts is placed in a first direction, the pair of shaft parts extends in a second direction orthogonal to the first direction, the pair of shaft parts is fastened by a pair of nuts, a bridge part connects one end of each of the pair of shaft parts, and a photonic crystal thin film is stuck to at least a part of at least one shaft part of the pair of shaft parts and changes its color according to strain of the shaft part;
generating an observation image obtained by imaging at least a part of at least one shaft part of the pair of shaft parts to which the photonic crystal thin film is stuck;
detecting a strain of the shaft part based on a color of an observation area, wherein the observation area includes an image of the photonic crystal thin film in the observation image; and
outputting, based on the strain of the shaft, fastening information, wherein the fastening information is associated with to fastening of the shaft part by the nut on the basis of the strain.

6. A detection device detecting a fastening state of the shaft part of a U-bolt by a nut, comprising a processor configured to execute operations comprising:
generating an observation image by imaging at least a part of at least one shaft part of a pair of shaft parts to which a photonic crystal thin film is stuck, wherein the U-bolt comprises a pair of shaft parts arranged in a first direction, extending in a second direction orthogonal to the first direction, and fastened by a pair of nuts, a bridge part connecting one end of each of the pair of shaft parts, and a photonic crystal thin film which is stuck to at least a part of at least one shaft part of the pair of shaft parts and changes its color according to strain of the shaft part;
detecting strain of the shaft part to which the photonic crystal thin film is stuck based on a color of an observation region including an image of the photonic crystal thin film in the observation image; and
outputting fastening information related to the fastening on the basis of the strain.

7. The U-bolt according to claim 2, further comprising:
a reference thin film, wherein the reference thin film is stuck to at least a part of a portion different from a portion to which the photonic crystal thin film is stuck, the reference thin film does not change its color according to the strain, and the reference thin film has the color of the photonic crystal thin film when a target axial force acts on the shaft part.

8. The U-bolt according to claim 2, wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.

9. The U-bolt according to claim 3, wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.

10. The U-bolt according to claim 1, wherein the U-bolt fixes a fastening object to a fastened object, wherein the fastening object includes a pipe, and the fastened object includes a wall surface.

11. The construction method according to claim 5, wherein
in a state where the pair of shaft parts are inserted into a pair of through-holes provided in a fastened object and a fastening object is sandwiched and fixed between the U-bolt and one surface of the fastened object, the photonic crystal thin film is positioned between one surface of the fastened object and a boundary between the shaft part and the bridge part in at least one shaft part.

12. The construction method according to claim 5, wherein a reference thin film is stuck to at least a part of a portion different from a portion to which the photonic crystal thin film is stuck, the reference thin film does not change its color according to the strain, and the reference thin film has the color of the photonic crystal thin film when a target axial force acts on the shaft part.

13. The construction method according to claim 5, wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.

14. The construction method according to claim 5, wherein the U-bolt fixes a fastening object to a fastened object, wherein the fastening object includes a pipe, and the fastened object includes a wall surface.

15. The detection device according to claim 6, wherein
in a state where the pair of shaft parts are inserted into a pair of through-holes provided in a fastened object and a fastening object is sandwiched and fixed between the U-bolt and one surface of the fastened object, the photonic crystal thin film is positioned between one surface of the fastened object and a boundary between the shaft part and the bridge part in at least one shaft part.

16. The detection device according to claim 6, wherein a reference thin film is stuck to at least a part of a portion different from a portion to which the photonic crystal thin film is stuck, the reference thin film does not change its color according to the strain, and the reference thin film has the color of the photonic crystal thin film when a target axial force acts on the shaft part.

17. The detection device according to claim 6, wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.

18. The detection device according to claim 6, wherein the U-bolt fixes a fastening object to a fastened object, wherein the fastening object includes a pipe, and the fastened object includes a wall surface.

19. The detection device according to claim 15, wherein
a reference thin film is stuck to at least a part of a portion different from a portion to which the photonic crystal thin film is stuck, the reference thin film does not change its color according to the strain, and the reference thin film has the color of the photonic crystal thin film when a target axial force acts on the shaft part.

20. The detection device according to claim 15, wherein
the photonic crystal thin film further comprises a plurality of photonic crystal thin films, wherein respective photonic crystal thin films of the plurality of photonic crystal thin films has different color characteristics from each other, and
a difference between a first color and a second color is larger than a difference between a third color and a fourth color, wherein the first color represents a color in which the respective colors of the plurality of photonic crystal thin films are mixed when the strain is within a first range, the second color represents a color in which the respective colors of the plurality of photonic crystal thin films are mixed when the strain is within a second range different from the first range, the third color is a color of one photonic crystal thin film from among the plurality of photonic crystal thin films when the strain is within the first range, the fourth color is a color of one photonic crystal thin film when the strain is within the second range.
